(19) United States
(12) Patent Application Publication
(10) Pub. No.: US 2007/0162743 A1
(43) Pub. Date: Jul. 12, 2007

(54) SLIDING ACOUSTICAL SIGNATURES

(75) Inventors: Kenneth D. Steinberg, Nashua, NH (US); Eric D. Masson, Derry, NH (US)

Correspondence Address: MAINE & ASMUS, 100 MAIN STREET, P O BOX 3445, NASHUA, NH, 03061-3445, US

(73) Assignee: SAVANT PROTECTION, INC., Nashua, NH (US)

(21) Appl. No.: 11/622,501

(22) Filed: Jan. 12, 2007

Related U.S. Application Data
(60) Provisional application No. 60/758,422, filed on Jan. 12, 2006.

(51) Int. Cl. H04L 9/00

(52) U.S. Cl. 713/156

(57) ABSTRACT

An acoustical key generated from a finite random data source of a random acoustical signature, wherein a key generator generates the acoustical key. The key generator creates a bit field array of bit values from a data file and derives a plurality of intersection points of the array with the finite random data source to form the key with the bit values. In one embodiment, the data file is unaltered and the key can be used to authenticate the data file if used for data integrity. In another embodiment, at least one Tau offset may be used to establish a first bit value for said filling of the two dimensional array. In addition, at least one Phi offset may be used to establish a first key value for the key.

### RELATED APPLICATIONS

This application claims the benefit of U.S. Provisional Application No. 60/758,422, filed Jan. 12, 2006, and this application is herein incorporated in its entirety by reference.

### FIELD OF THE INVENTION

The invention relates to the generation of a unique key and in more particular detail, to validation and integrity of data sources using a key.

### BACKGROUND OF THE INVENTION

One of the more common problems in the field of cryptography and computer security relates to the generation of unique mathematical values. These values are often used to create hash tables, cryptography keys, or encryption seeds.

Hash tables are used to provide a quick means for finding a fragment of information in a large data set. Normally an algorithm is applied to the data set creating an index through which information can be retrieved using a method other than a sequential search. The primary concept is the creation of a fast index table based on the data itself.

Encryption and cryptography often require at least one random or pseudo random value to be used in a larger mathematical equation as a means of introducing uniqueness. These values are normally called seed values and are the subject of enormous amounts of mathematical research. The common belief is the more random the seed values the more random the cryptographic result, thereby making the encrypted information harder to read or extrapolate. Even with encryption, it is sometimes necessary to authenticate the unencrypted data to ensure that it is the same as the original data source that was subjected to encryption.

In the area of Trusted Computing, the validation of one or more parties involved in data use or exchange are typically assigned portions of keys used in conjunction with authentication schemes to create trust. Trusts can be used to allow or deny access to computing resources or to accredit parties in a data exchange. Normally the parties to be trusted are provided with a unique key derived from a mathematical calculation including randomness in order to avoid easy duplication or derivation of keys which would allow unauthenticated parties access to private information.

The security and computer industry continually strive to create means by which non-uniform or random values can be derived from information which is visible and lacking in inherently arbitrary data. However, there are a growing number of hackers and computer users that are sophisticated and ingenuous. The data that is typically sent through such secure modes is generally sensitive data such as personal information and financial transactions. A breach of the data can have a tremendous effect and dire consequences.

Another area that relies upon data validation and authentication is in relation to the compression tools that compress data files for transmission and then uncompress the data on the other end. The industry requires systems that can validate that the uncompressed data is the same as the original compressed data.

What is needed, therefore, are techniques for providing secure modes of operation. Such a system should use a schema that is less prone or vulnerable to attacks and being cracked.

### SUMMARY OF THE INVENTION

One embodiment of the present invention relates to generating arbitrary mathematical values from a common data set. These values can be used as either seed values in larger mathematical equations or in their original form as keys or hash values into information stores.

A further embodiment of the present invention describes a system that can validate a data source in an efficient and timely manner. An original data source is processed with an acoustical random waveform, digital or analog, to generate a key to validate the original data source. In one aspect, the present invention provides for a three seed key system using a unique waveform, a unique Phi and a unique Tau.

Another embodiment allows for a user to identify changes to information as it is transmitted or used between two or more computing systems. A further aspect refers to identifying changes to information which is stored and must remain intact over time and reuse by one or more systems.

Yet another embodiment of the present invention is to provide a means of establishing trust either between computing entities or the user(s) of a computing system.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1a illustrates the relationship between fixed data sources and signatures according to one embodiment of the present invention.

FIG. 1b illustrates the relationship between streaming data sources and signatures according to one embodiment of the present invention.

FIG. 2 is a simplified diagrammatic perspective of components for the key generation wherein a random data source is used to generate the signature in accordance with one embodiment of the present invention.

FIG. 3 is a graphical representation showing the random nature of digital and analog acoustical waveforms selected from a portion of a chaos pool configured in accordance with one embodiment of the present invention.

FIG. 4 illustrates Phi seeding wherein the random Phi values are changed per key in accordance with one embodiment of the present invention.

FIG. 5 graphically depicts the bit field generation from the data source used to form a two dimensional data structure configured according to one embodiment of the present invention.

FIG. 6 illustrates the random nature of the bit field seeding from any point in the data source in accordance with one embodiment of the present invention.

FIG. 7 graphically illustrates the key generation in accordance with one embodiment of the invention.

FIG. 8a shows the random nature of the key generation for the same data source configured in accordance with one embodiment of the invention.

FIG. 8b shows the random nature of the key generation for the same data source configured in accordance with another embodiment of the invention.

FIG. 9a illustrates the use of the Sliding Acoustical Signatures as a means of data integrity checking and identification in relation to Hash generation configured in accordance with one embodiment of the invention.

FIG. 9b illustrates the use of the Sliding Acoustical Signatures as a means of data integrity checking and identification in relation to Cryptography configured in accordance with one embodiment of the invention.

FIG. 9c illustrates the use of the Sliding Acoustical Signatures as a means of data integrity checking and identification in relation to data integrity configured in accordance with one embodiment of the invention.

FIG. 9d illustrates the use of the Sliding Acoustical Signatures as a means of data integrity checking and identification in relation to Trusts configured in accordance with one embodiment of the invention.

FIG. 10a depicts an alternate means for building the bit field and selection waveform by using non-contiguous selection of Tau in one embodiment.

FIG. 10b depicts another alternate means for building the bit field and selection waveform by using non-contiguous selection of Phi in one embodiment.

FIG. 11 describes the process by which one would derive a key from a data source configured in accordance with one embodiment of the present invention.

FIG. 12 describes the process by which one would validate a data file using the SAK, configured in accordance with one embodiment of the present invention.

### DETAILED DESCRIPTION

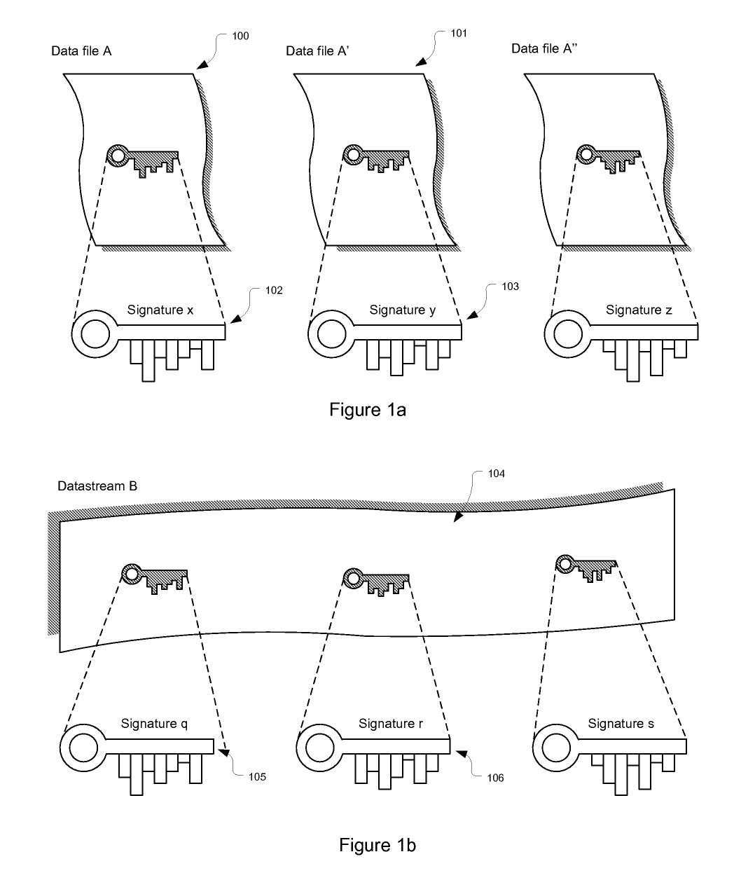

Referring to FIG. 1a and FIG. 1b, sources of information, or data can come in many forms as is known in the art. Generally, a data source, also herein termed a data file, is presented as either fixed size data sources 100 and 101 or as streams of data 104. The data files 100, 101, 104 can be pictures, images files, Word documents, PDF documents, application programs or even operating systems. In any case, the Sliding Acoustical Signatures (SAS) provides a methodology for deriving unique values (keys) regardless of whether the data files are identical or an ongoing stream of differing data files. The signature keys 102, 103, 105, 106 are shown as being extracted from the data files 100, 101, 104, however it should be understood that the key in one embodiment is not part of the data file, rather, the data file is unaltered by the SAK processing without changing the original data file.

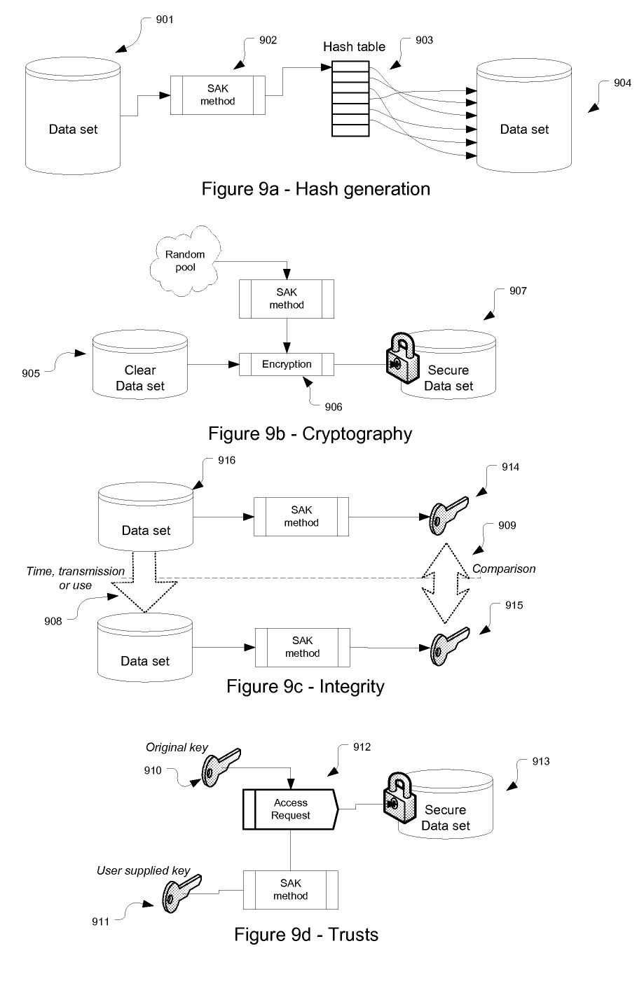

Referring again to FIG. 1a, in one embodiment the A and A′ data files 100, 101 are identical and processed to derive unique signatures 102, 103. In FIG. 1b, differing data files 104 are also processed to derive different keys 105, 106. These keys can then be used in a variety of data validation, encryption, and access techniques wherein some applications are shown in FIGS. 9a-9d.

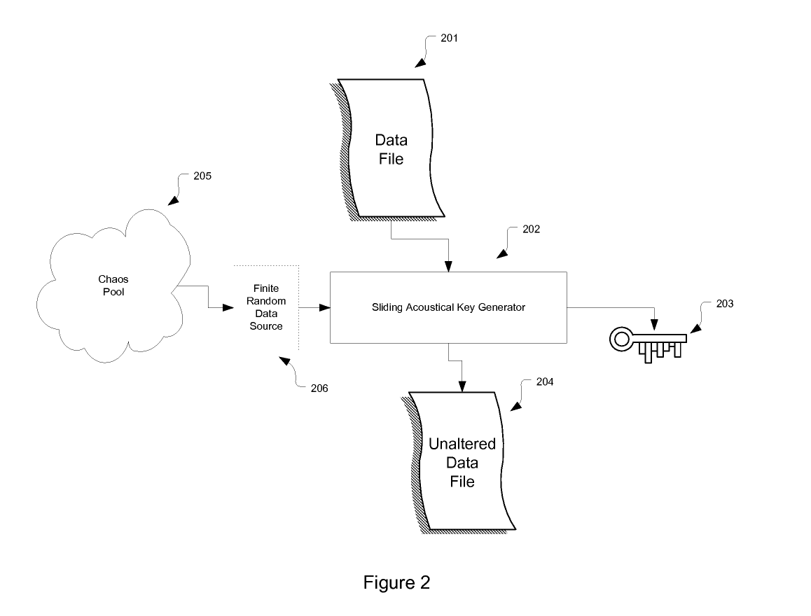

According to one embodiment illustrated in FIG. 2, the basic components used to derive a Sliding Acoustical Key (SAK) consists of three elements; the data file 201, the key generator 202 and the finite random data source 206. The finite random data source 206, for illustrative purposes, can be thought of as a waveform similar to a sound waveform, although not necessarily a true representation of an actual sound wave.

The finite random data source 206 can be selected from any of the random sources or chaos pool 205, wherein the implementer can select the appropriate source or it can be automatically selected. Some examples of the possible chaos pool sources 205 includes actual sound, system noise, an external sensor, an entropy pool, random number generator, and user input. Each of these sources can be used to derive random numerical values. For example, an audio wave file such as a song can be the acoustical random chaos pool 205, wherein a 5 second segment of the song can be the finite random data source 206.

The length or size of the random values from the chaos pool 205 is typically very large, wherein the finite random data source 206 is a small segment. Furthermore, the total length of the random values from the finite random data source 206 is generally much longer than total length of the key 203. The random values from the finite random data source 206 are specified by a key length and within a key range that can be established by the implementer or otherwise established by the system.

Using the random values from the finite random data source 206, a data set is created by the key generator 202 which contains random data values from the finite random data source waveform within a predetermined range [0, 1, 2, 3 . . . N] of index points and of a length considerably longer than the intended key 203 size. The range and key size can be determined by the implementer depending on design criteria or otherwise programmed or designated.

The end result of applying a key generator 202 with the original data file 201 and using the finite random data source 206 is a unique key 203 that is associated with the data file 201. The processed data file 204 represents a preserved original data source 201 with key information such that the signature key 203 can authenticate the data 204. Unlike certain validation or encryption schemes that alter the original data file 201, one embodiment of the present invention preserves the original data file 201 and provides a key 203 to validate that processed unaltered data file 204.

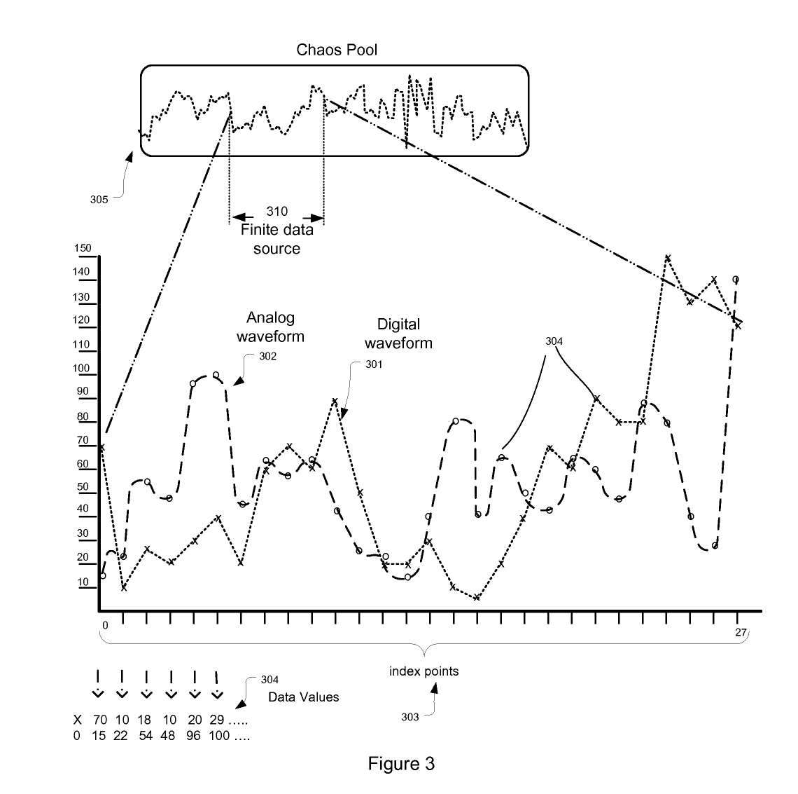

As shown in FIG. 3, using a portion of the raw random data in the chaos pool 305, a filtering process is applied, such as user selection, which creates the length of the finite random data source 310 used in the SAK process. The finite data source can be a digital waveform 301 or analog waveform 302, wherein both are presented for illustrative purposes. The two dimensional graph shows two axes, which can be amplitude on one axis (Y axis) and time on the other axis (X Axis). As illustrated, the ‘amplitude’ is shown as ranging from 0-150 units. The ‘width’ of the waveform section is shown as ranging from 0-27 units. As should be readily apparent, the units can vary and be positive or negative and represented in relative terms.

Sampling of the digital 301 or analog 302 waveforms results in a set of values 304 denoted by ‘X’ on the digital waveform 301 and ‘O’ on the analog waveform 302. The sampling rate establishes the number of data values selected over the waveform length. Within a given length, a high sampling rate generates more data points 304 while a lower sampling rate produces less data values 304. A single unvaried sampling rate generates a number of data values 304 with evenly spaced periods between each index point 303. For convenience, the sampled data points 304 are shown for each of the index points 303 on the graph. In other embodiments the sampling rate can establish different data points 304 on the wavelength. According to one embodiment, if the waveform went beyond the threshold limits, it would be clipped at the limit.

In one embodiment the key length is the number of sampled data values 304. The finite random data source 310 is typically many multiples of length longer than the key length in order to reinforce randomness. The key length can be every sampled data value or a multiple of the data values 304 depending upon the requirements.

Referring again to FIG. 3, an example of two sets of random values 304 are illustrated for both a digital 301 and analog 302 waveforms. As noted, the height or amplitude in this embodiment is 0 to 150. The key length or waveform width is extracted from a segment of the total length having a start point and a stop point, which in this example is the range of 0 to 27. The following table illustrates the data values 304 for both the digital waveform 301 and the analog waveform 302 for each sample point, which in this example is the same as the index position 303.

TABLE A
data values at the sampling frequency

| Index Position | X | O |
|---|---|---|
| 0 | 70 | 15 |
| 1 | 10 | 22 |
| 2 | 27 | 54 |
| 3 | 20 | 48 |
| 4 | 25 | 96 |
| 5 | 29 | 100 |
| 6 | 22 | 45 |
| 7 | 60 | 64 |
| 8 | 70 | 59 |
| 9 | 61 | 75 |
| 10 | 89 | 42 |
| 11 | 50 | 26 |
| 12 | 20 | 25 |
| 13 | 20 | 15 |
| 14 | 28 | 41 |
| 15 | 10 | 82 |
| 16 | 5 | 46 |
| 17 | 20 | 69 |
| 18 | 40 | 63 |
| 19 | 70 | 45 |
| 20 | 64 | 70 |
| 21 | 91 | 66 |
| 22 | 81 | 52 |
| 23 | 81 | 94 |
| 24 | 150 | 84 |
| 25 | 130 | 40 |
| 26 | 141 | 30 |
| 27 | 122 | 142 |

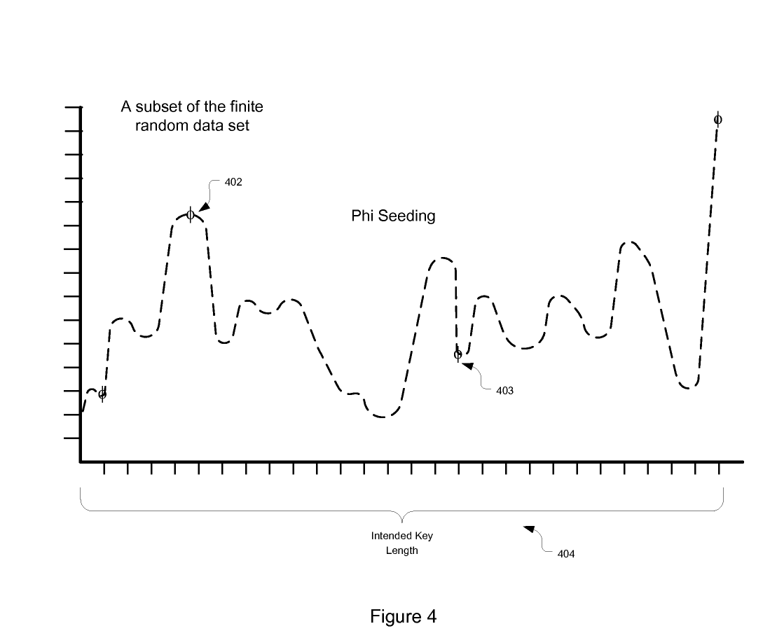

Referring to FIG. 4, while the finite random data source provides one input into the derivation of a Sliding Acoustical Signature, further randomness can be introduced by the use of a random offset. In one embodiment, a random offset called Phi 402 can be used, which is a per-key value used to determine the location of the random values from the finite random data set. In other words, where on the waveform you start and/or stop to take the data points for the given key length 404. In one embodiment, a starting Phi 402 can be used to commence the data values and a stopping Phi 403 can signify the end, thereby specifying a subset of the finite waveform. There can be more than one subset as specified by more than one pair of start and stop Phi values. The number of Phi offset values and the index position location for the Phi offset can be determined by the user and the design criteria.

The Phi offset values are recorded for use in the SAS processing as detailed herein. For another input data source, another and different Phi offset value can be used and may also change per user or end-point in a concept called Phi Seeding. For illustrative purposes, an example is illustrated in FIG. 4 which shows the analog waveform. There are four Phi values noted at index point locations 1, 5, 16, and 27. These could represent two subsets having data values for a first subset at index locations 1 to 5 and a second subset at index locations 16 to 27.

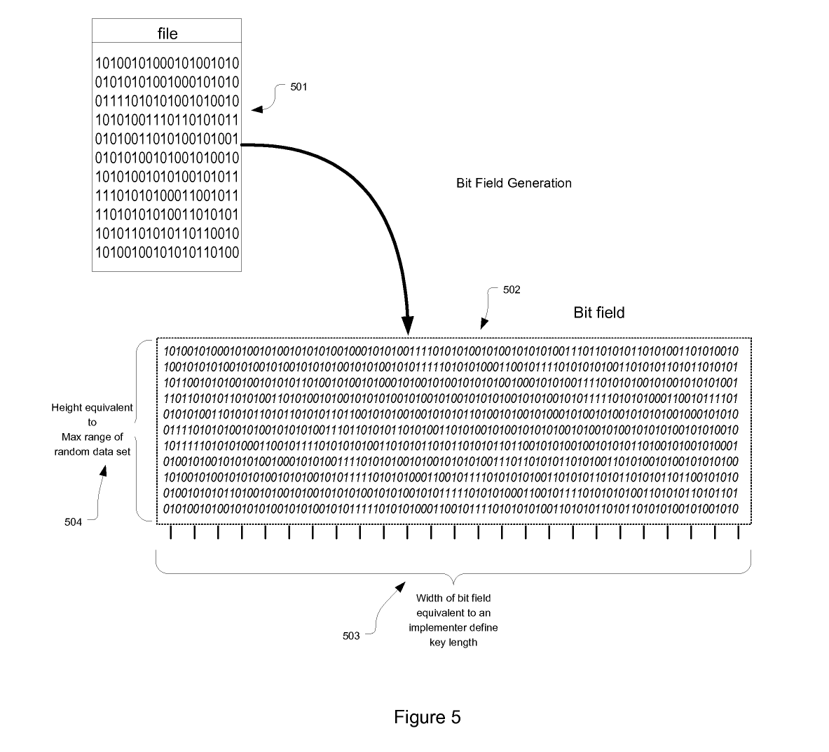

Referring to FIG. 5, the original data file 501 can be digitally represented as a set of bits in a file. The bits are taken from the data file 501 and placed into a two dimensional array called the bit field 502 in order to fill the bit field using only the bits from the original data source file 501. The bit field 502 in one embodiment is as wide as the predetermined key length 503 and as deep or high 504 as the range for the random data source. In other words, the bit field height 504 is as high as the maximum range of the waveform. The bits are wrapped around and repeated until the bit field 502 is filled.

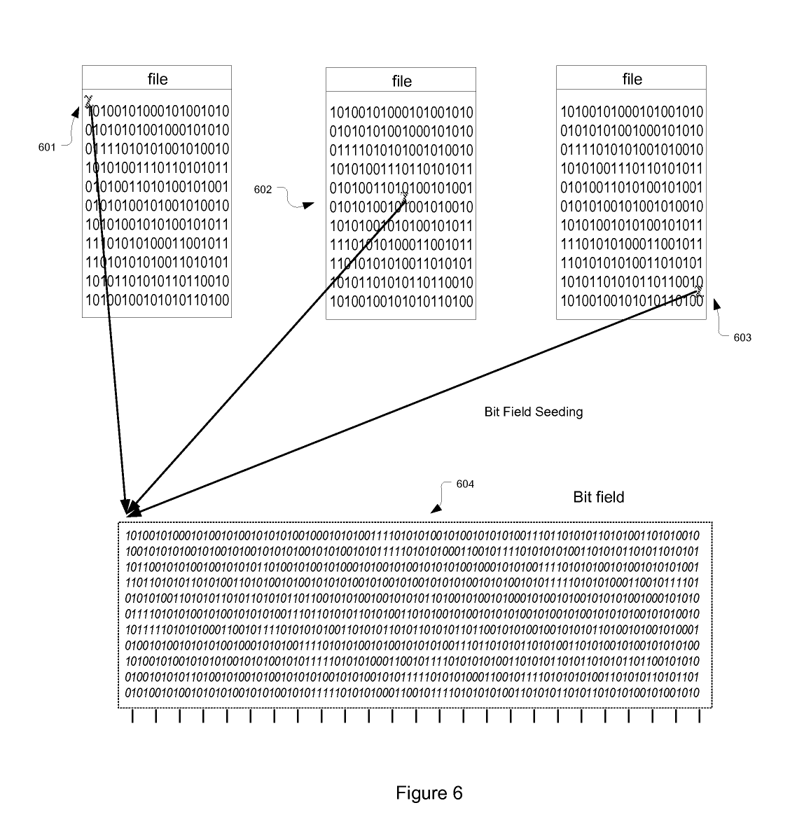

Referring to FIG. 6, the random nature of bit field seeding is depicted in accordance with one embodiment of the invention for three identical data sources 601, 602, 603. The location or offset within the data source from where the bit field 604 is populated is referred to as Tau, wherein Tau is randomly chosen for each data source and may vary by user, system, or endpoint. As noted, the bit filed 604 is generated by using the bits from the original data sources 601, 602, 603, however by using a Tau offset, the starting point for filling the bit field provides a further random characteristic for the present invention. Regardless of the data source a new Tau offset is chosen for every data source. Tau might be at the data source beginning 601, the data source end 603, or in the middle of the data source 602. Values are taken from the data source until the bit field is full. As detailed herein, some cases this might entail wrapping to the beginning of the data source.

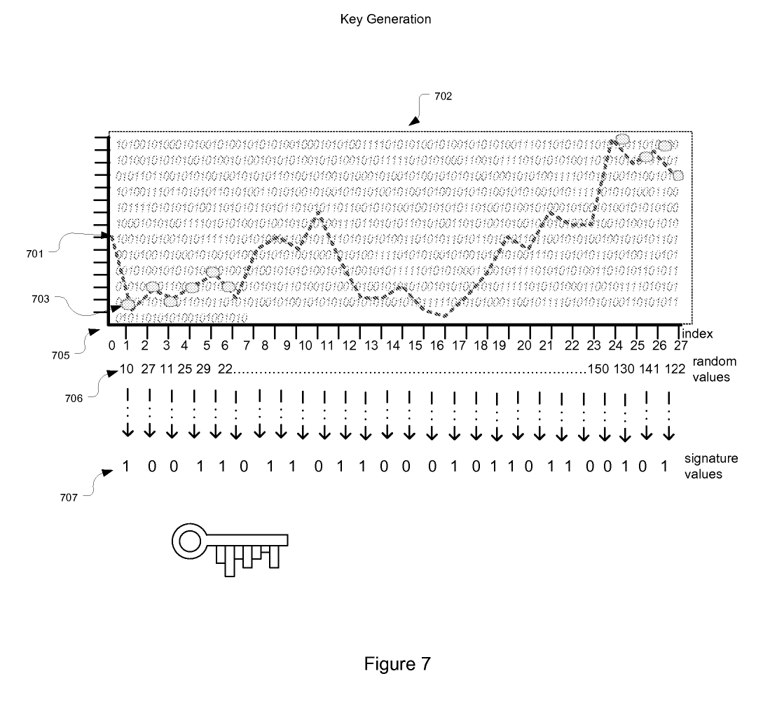

FIG. 7 graphically illustrates the key generation in accordance with one embodiment of the present invention. In simple terms, the key generation represents the intersection 703 of the random waveform 701 with the bit field 702 and recording those signature values 707. The signature generation process analyzes the intersection of the bit field 702 and at least a subset of the random waveform 701. One mechanism for obtaining the overlay is to note the value height index 706 (denoted as the Y axis) with the corresponding key index 705 (denoted as the X axis) and locating the appropriate bit field value in the two dimensional bit field array 702. The intersection of the each key index 705 and the height index 706 are used to derive the final signature value 707.

In more particular detail, the bit field value for the (index=1, height=10) is a 1; (index=2, height=27) is a 0; (index=3, height=11) is a 0; and so on.

There are many variations within the scope of the invention, some of which are detailed herein. For example, a simplified key 707 can be the entire set of signature values 707 resulting from overlaying the waveform onto the bit field 702 without imparting the further aspects of the Phi and Tau offsets. A subset of the key is also within the scope of the invention by utilizing the Phi offset values.

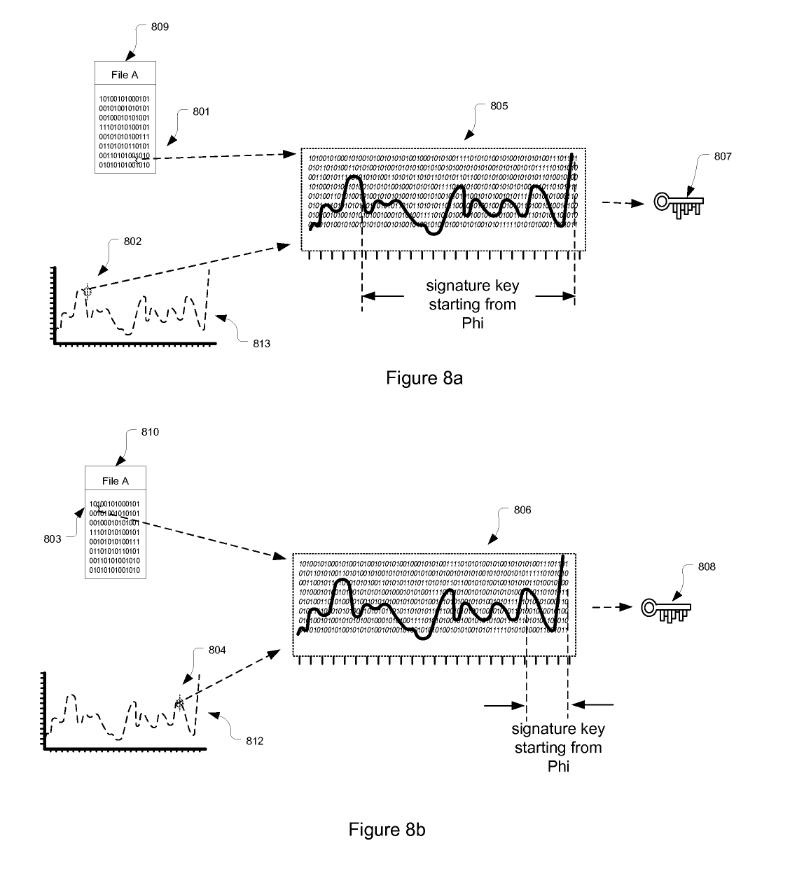

Referring to FIG. 8a and FIG. 8b, certain additional variations of the key generation are depicted by utilizing some features associated with the Phi and Tau offsets. Referring to FIG. 8a, starting from the data source file 809, the bit field 805 is filled commencing from the Tau offset 801 thereby adding a random attribute, wherein the data file values are wrapped around once the end of the file 809 is reached. Using a graphical representation, the waveform 813 is overlaid onto the bit field 805, however a further random quality is added by using Phi 802 as the starting point to generate the signature 807. For example, assuming that the Phi offset 802 is at index location 5, the resulting key 807 would be the intersection points produced by overlaying the waveform on the bit filed starting from index location 5 and extending to the end of the index points.

In FIG. 8b, even assuming that the original data source 810 and the waveform 812 is the same as the data source 809 and waveform 813 of FIG. 8a, the resulting signature 808 is different because of the Tau offset 803 and the Phi offset 804. For example, the signature 808 would be the intersected bit values commencing from the index location noted by the Phi offset 804. For example, the bit field 806 is filled starting at a different Tau value 803. And, the key 808 is generated starting at a different Phi 804.

The values of Tau 801, 803 and the values of Phi 802, 804 can change per use (or system or endpoint). The random waveform data set 812, 813 can also be changed to increase signature security and randomness. As a result of the varying SAS seed values, the same data source 809, 810 will yield different signatures 807, 808. Using the SAS process, completely different signatures can be derived using identical data sources 809, 810 regardless of user or location. The original data sources 809, 810 can retain their integrity and yet have unique signature keys according to the many variations detailed herein.

There are numerous applications that may implement the present invention. For example, referring to FIG. 9a, one application of the present invention includes creating hash tables 903 for data sets 901 by deriving signatures 902 which can be used as an index into the original data set 904.

Referring to FIG. 9b, the present invention might also be used to create a seed values for data encryption. While not encrypting the data itself, the present invention yields seed values that can be used by the encryption or for validation that the unencrypted data matches the original. The encryption unit 906 of the data set 905 might include the SAS input 908 resulting in a uniquely encrypted data set 907.

A further embodiment is illustrated in FIG. 9c, wherein the Sliding Acoustical Signatures can also be used to validate data integrity of a data set 916 after a period of time or transmission 908 by performing a comparison 909 of signatures before 914 and after 915. For example, a data file can be stored for years and later authenticated using the present invention. Other embodiments include validation after compression or encryption. And still other embodiments include validation of transmitted data, such as files or images sent by wired or wireless schemes, such that the end user can validate the data.

Referring to FIG. 9d, the Sliding Acoustical Signatures might also be used as part of trust relationships by being used as part of an access request 912 to a data set or system 913 by providing a portion 911 of a user key to be coupled with any number of complimentary keys 910 as a means of validating trusts.

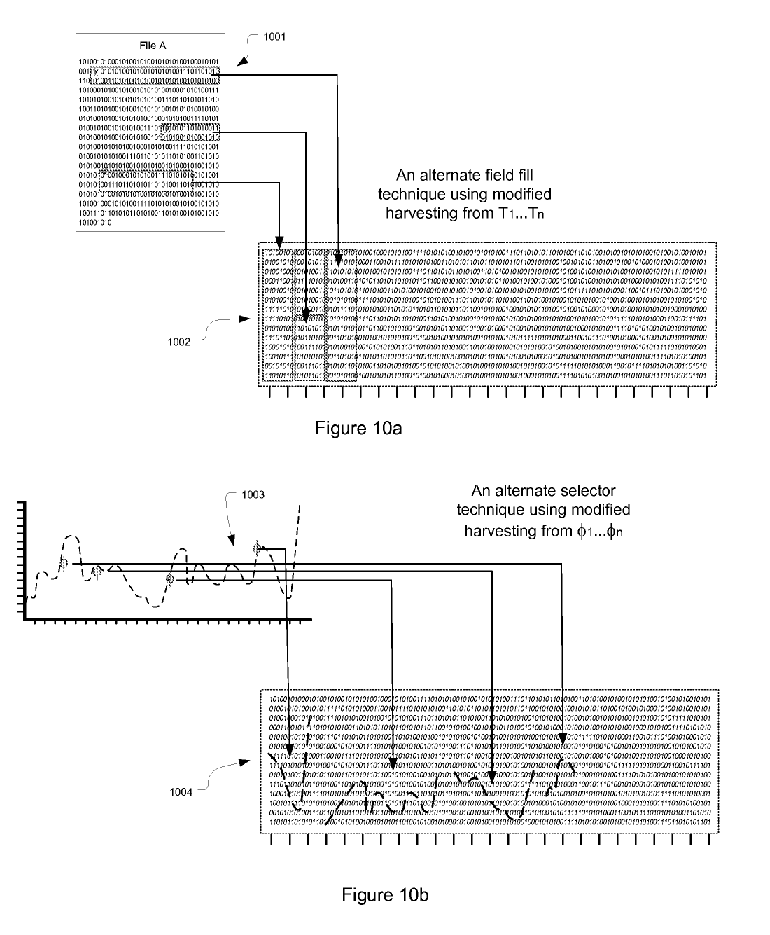

FIG. 10a and FIG. 10b illustrate still further alternatives to the use of Tau and Phi. In FIG. 10a, an alternative filed fill technique using modified harvesting from T₁_{-T}ₙ is depicted. Tau, being the location within a data source from which the bit field 1002 is populated, may be designated as non-contiguous, disparate offsets 1001. The bit field generation processing can extract portions of the original data source 1001 as designated by one or more blocks derived from Tau offsets in order to fill the bit field 1002.

Similarly, as shown in FIG. 10b, an alternate selector technique is depicted using modified harvesting from Phi₁-Phiₙ. Phi can be used to generate entirely unique signatures. Phi, being the offset from which the random data set is chosen, can also be non-contiguous 1003 locations resulting in disjoint data sets that still provide full key range coverage. The Phi values 1003 can denote start and stop positions to generate one or more subsets for intersection with the bit field 1004.

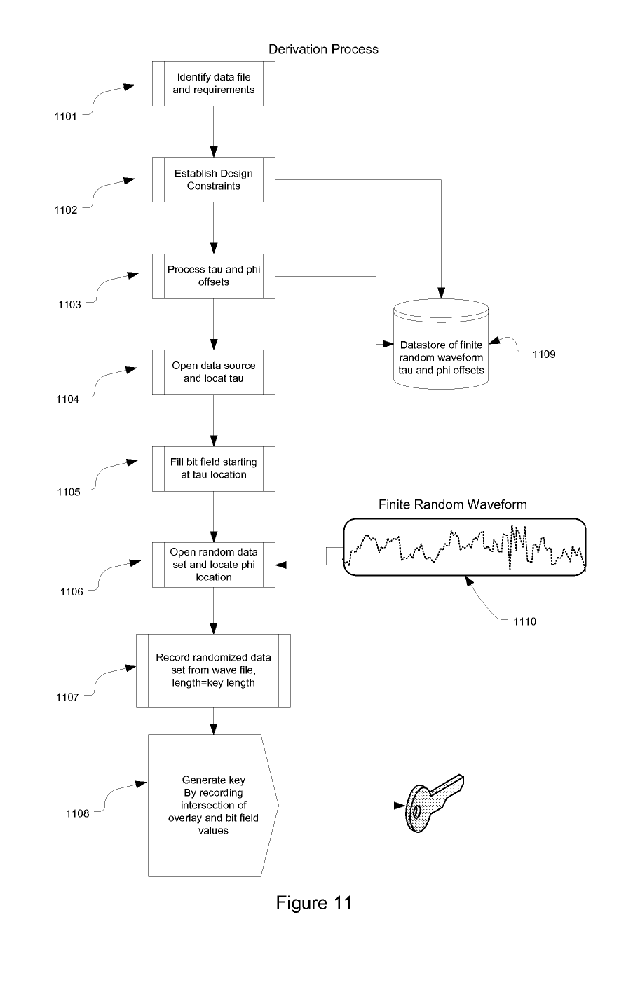

Referring to FIG. 11, a derivation process for generating a Sliding Acoustical Signature according to one embodiment is depicted. The implementer identifies the original data file which will be subject to processing 1101. The data file has certain characteristic depending upon the type of file and the size of the file. As detailed herein, the data file can be any file such as a small image file, a Word document or an operating system.

The implementer may use characteristics of the data file along with certain design criteria to establish design constraints 1102. The design criteria may be a level of security such as low security which would not require a lengthy key. Alternatively, a higher level of security may encompass multiple offsets and a longer and more complex key. The various design criteria include at least the type of random data source from the chaos pool, the size of the finite segment of the random data source, the sampling rate, the number of index points, the height of the allowed waveform, the number and type of Phi and Tau offsets. Referring again to FIG. 3, some of these variables are graphically depicted. The design constraints can be automatically programmed or developed via user intervention. Certain parameters from the established design constraints are stored in a datastore 1109, such as the finite random waveform.

In certain embodiment, the optional Tau and Phi offset values are processed 1103. The data store 1109 can also hold the values of Tau and Phi for each data source to which the SAS process is applied as this may be required for subsequent validation in conjunction with the validation processing. The data store 1109 may be encrypted or otherwise secured.

With these established values and parameters, the data file is opened and the location of Tau in the data file is located 1104. From this location(s) the bit field is filled 1105. As noted herein, the height of the bit field is equivalent to the maximum range of the finite random date source and the width of the bit field is equivalent to the key length. There may be multiple Tau parameters used for the bit field generation as illustrated in FIG. 10a.

At this point, the random finite data source is opened and the location of Phi is sought 1106 in order to establish the Phi seeding. The start/stop locations are located as a subset of the finite random data source. As noted herein, there can be multiple Phi offsets as shown in FIG. 10b.

From this location a subset of the random data set 1110 with the length of the desired signature, is recorded 1107. Using this subset, the values in the bit field which intersect the subset values are recorded as the key 1108. This signature is then put to use as specified by the implementer.

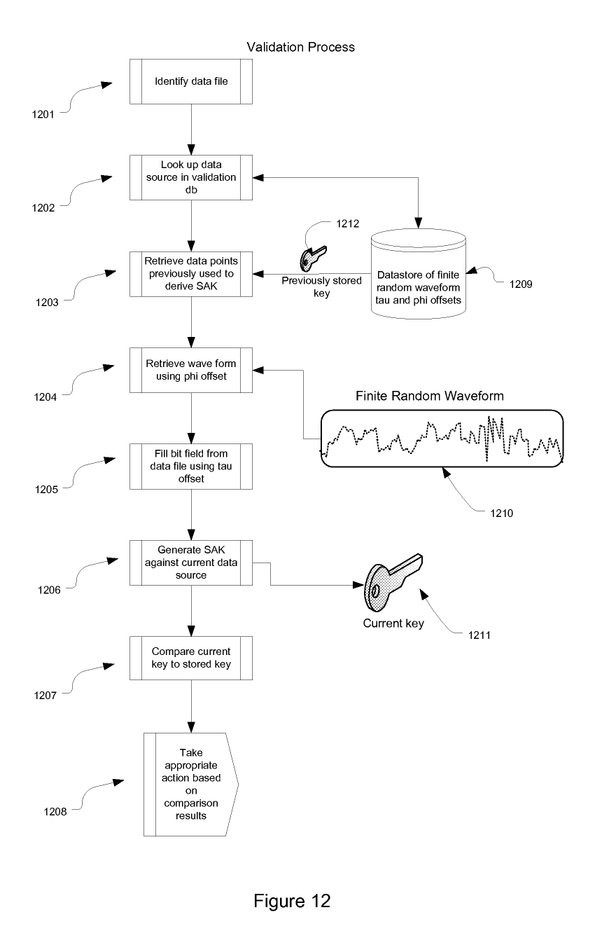

Referring to FIG. 12, there are several implementations of the methodology of the present invention which require the recreation of a key, such as data integrity. The implementation should first identify the current date file 1201 for which validation is sought and determine if the data file is known to the implementor. Supporting this processing are two datastores, namely the datastore housing the Tau and Phi offsets 1209; and the finite random waveform 1210. The datastores 1209, 1210 as well as the previously stored key 1212 is required for authentication.

If previously known, the related information is located 1202 in the data store 1209. The processing retrieves the data points used to derive the sliding acoustical key 1203. Using the Phi offset from the original SAK derivation, the subset of the random data set based on the Phi seeding is retrieved 1204 from the finite random data source 1210 and stored for the SAK derivation.

Using the Tau offset, the bit field is filled 1205 using the current data file. With the bit field in place the current SAK 1211 is generated for the current data file 1206 for use in generation of the current key 1211. The current key is then used for validation or as comparison to the previously known key 1207 for the current data file. The current key is then compared to the previously stored key 1207 in order to determine if the current date file is the same as the original data file. The implementer can then take the appropriate action 1208 depending on the results.

As noted in FIGS. 9a, 9b, 9c, and 9d, the generated key from the SAK processing can be used for other functions besides data integrity.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A system for generating an acoustical key for a data file, the system comprising:
a set of random acoustical signatures;
a finite random data source from one of said set of random acoustical signatures; and
a key generator that generates said acoustical key, wherein said key generator creates a bit field array of bit values from said data file and derives a plurality of intersection points of said array with said finite random data source to form said key with said bit values, and wherein said data file is unaltered.

2. The system of claim 1, wherein said bit field array is filled starting at a Tau offset location for a first bit value.

3. The system of claim 1, wherein said intersection points of said array with said finite random data source starts at a Phi offset.

4. The system of claim 1, wherein said key, said finite random data source are stored for later authentication of said data file.

5. A method for generating a signature key for a data file, comprising:
establishing a set of design constraints for said key;
opening said data file to identify a plurality of bit values;
filling a two dimensional array with said bit values;
overlaying a random acoustical waveform onto said two dimensional array; and
identifying a set of key values at the intersection of said acoustical waveform and said two dimensional array to form said acoustical key.

6. The method of claim 5, further comprising processing at least one Tau offset, wherein said Tau offset establishes a first bit value for said filling of said two dimensional array.

7. The method of claim 5, further comprising processing at least one Phi offset, wherein said Phi offset establishes a first key value for said identifying of said key values.

8. The method of claim 5, wherein said design constraints are selected from at least one of the group consisting of: type of random data source, size of finite random data source, sampling rate, number of index points, height of allowed waveform, number of Phi offsets, and number of Tau offsets.

9. The method of claim 8, wherein said design constraints are user programmable.

10. The method of claim 5, further comprising Phi seeding.

11. The method of claim 5, wherein said data file is unaltered after said generating of said key.

12. A validation system for a data file, comprising:
a sliding acoustical key generated from an intersection of a plurality of bit values from said data file within a two dimensional array overlaid with an acoustical finite random waveform, wherein said key and said waveform are stored, and wherein said data file is unaltered; and
a suspect data file validated by generating a new key from an intersection of a plurality of bit values from said suspect data file within a two dimensional array overlaid with said stored acoustical finite random waveform, and wherein said new key is compared to said key to confirm validation.

13. The system of claim 12, further comprising processing at least one Tau offset, wherein said Tau offset establishes a first bit value for said filling of said two dimensional array.

14. The system of claim 12, further comprising processing at least one Phi offset, wherein said Phi offset establishes a first key value for said identifying of said key values.

15. The system of claim 12, wherein a width of said two dimensional array is a user defined key length.

16. The system of claim 12, wherein a height of said two dimensional array is equal to a range of said finite random data source.

17. The system of claim 12, wherein said acoustical finite random waveform is selected from at least one of the group consisting of: actual sound, system noise, external sensor, entropy pool, random number generator, and user input.
